(19) United States
(12) Patent Application Publication
(10) Pub. No.: US 2026/0084497 A1
(43) Pub. Date: Mar. 26, 2026

(54) FUNCTION EXTENSION BOARD FOR AUTOMOBILE DOORS AND WINDOWS

(71) Applicant: Heng ZHANG, Xiangyang, Hubei (CN)

(72) Inventor: Heng ZHANG, Xiangyang, Hubei (CN)

(21) Appl. No.: 18/859,320

(22) PCT Filed: Apr. 29, 2024
(86) PCT No.: PCT/CN2024/090477

§ 371 Date: Oct. 23, 2024

(51) Int. Cl. B60J 1/20; B60H 1/26; B60R 16/02

(52) U.S. Cl. CPC B60J 1/20; B60H 1/267; B60R 16/0215

(57) ABSTRACT

Provided is a function extension board for automobile doors and windows including a board body. An upper edge and side edges of the board body are provided with board convex edges corresponding to grooves of an automobile door and window frame and an automobile door frame. A lower edge of the board body is provided with a board groove corresponding to an upper edge of an automobile window lifting glass. A ventilation opening is formed in the board body. The board body is detachably provided with a rain cover on an outer side of the ventilation opening.

### CROSS-REFERENCE TO RELATED APPLICATION

This application is a national stage application of International Patent Application No. PCT/CN2024/090477, filed on Apr. 29, 2024, which is incorporated by references in its entities.

### TECHNICAL FIELD

The present disclosure relates to a function extension board for automobile doors and windows, and belongs to the technical field of automobile door and window accessories.

### BACKGROUND

Chinese Utility Model Patent Application NO. CN220410246U, entitled “Function Extension Board for Automobile Doors and Windows, and Specific Ventilation Broad Composed Thereof”, filed on Jan. 30, 2024 discloses an existing function extension board for automobile doors and windows, including a board body. An upper edge and side edges of the board body are provided with board convex edges corresponding to automobile door frame or automobile window frame grooves, and a lower edge of the board body is provided with a board groove corresponding to an upper edge of automobile window lifting glass. A ventilation opening is formed in the board body. A rain cover is fixed on the board body on an outer side of the ventilation opening. A functional area configured for mounting various functional components is further arranged on the board body. Although the functions of automobile doors and windows are effectively extended by means of such function extension board, the rain cover is fixed on the board body, causing that the function extension board is integrally of a specific-shaped structure, resulting in the inconvenience in storage and transportation. Moreover, the function extension board is not provided with a fixing-sealing structure for conducting wires, resulting in insufficient in extension function.

### SUMMARY

Aiming to solve the technical defect that the existing function extension board for automobile doors and windows is inconvenient to store and transport and insufficient in extension function, the present disclosure provides a novel function extension board for automobile doors and windows. According to the function extension board, the rain cover is designed to be detachable, so that the storage and transportation of the extension board are convenient. Meanwhile, through holes with downward outer orifices are formed in the board body within the rain cover, and the through holes are provided with rubber plugging pieces. The rubber plugging pieces can not only fixedly seal conducting wires running through the through holes, but also can seal the through holes in which the conducting wires are not mounted. Finally, clamping slots for clamping various function devices are further formed in the board body below the rain cover to realize reasonable arrangement of various functional components, so that the function extension abundancy of the extension board is greatly improved, and the function extension board is high in practicability.

The technical purpose of the present disclosure is realized through the following technical scheme:

A function extension board for automobile doors and windows is provided. The function extension board includes a board body. An upper edge and side edges of the board body are provided with board convex edges corresponding to grooves of an automobile door and window frame and an automobile door frame. A lower edge of the board body is provided with a board groove corresponding to an upper edge of an automobile window lifting glass. A ventilation opening is formed in the board body. The board body on an outer side of the ventilation opening is detachably provided with a rain cover.

Through the adoption of the above-mentioned technical scheme, a novel function extension board for automobile doors and windows is provided. According to the function extension board, the rain cover is detachably mounted on the board body on the outer side of the ventilation opening, so that the storage and transportation convenience of the function extension board can be effectively improved.

Furthermore, a fly net is detachably placed on the ventilation opening.

Through the adoption of the above-mentioned technical scheme, outside insects or sundries can be effectively avoided from entering into the carriage from the ventilation opening by arranging the fly net. The fly net is arranged to be detachable, so that various using requirements of people can be met. The fly net is assembled when flies need to be prevented, and the fly net is detached when not needed.

Furthermore, through holes allowing conducting wires to pass through are formed in the board body around the ventilation opening within the rain cover.

Through the adoption of the above-mentioned technical scheme, the through holes allowing conducting wires to pass through are formed in the board body within the rain cover, so that rainwater can be prevented from entering into the interior of the carriage from the through holes to a certain extent.

Furthermore, the through holes are correspondingly provided with rubber plugging pieces, each of the rubber plugging pieces includes a taper sleeve with a side opening, and a section of the taper sleeve is C-shaped.

Through the adoption of the above-mentioned technical scheme, a rubber plugging piece with an integrally tapered shape and a C-shaped section is provided. During use, the conducting wire is laterally assembled into the taper sleeve, and then the taper sleeve is inserted into the through hole to fixedly seal the conducting wire. The rubber plugging piece has the effects of simple operation and good fixation and sealing effects.

Furthermore, the taper sleeve consists of a C-shaped elastic steel plate and a rubber layer on an outer surface of the C-shaped elastic steel plate.

Through the adoption of the above-mentioned technical scheme, the elastic steel plate is arranged inside the taper sleeve. The elastic steel plate has good transverse deformability and also has good axial support force, so that radial sealing and axial insertion can be ensured effectively.

Furthermore, multiply sealing lips are placed a part, on inner sides of two support plates of the C-shaped elastic steel plate, of the rubber layers in a staggered manner.

Through the adoption of the above-mentioned technical scheme, the sealing lips are arranged inside rubber taper sleeve, and the sealing lips can ensure normal mounting of the conducting wires and also can be embedded into each other to seal the through holes when conducting wires are not mounted.

Furthermore, a bigger end of the taper sleeve is provided with a flexible connecting member, and the taper sleeve is placed on an inner surface of the board body through the flexible connecting member.

Through the adoption of the above-mentioned technical scheme, the taper sleeve is mounted on the inner side of the board body with the flexible connecting member, so that the rubber plugging piece can be effectively prevented from being lost during use, so that the convenience in use can be effectively improved.

Furthermore, the through hole is an oblique through hole obliquing downwards from inside to outside.

Through the adoption of the above-mentioned technical scheme, the through hole is provided with a downward outer orifice, outside rainwater can be further avoided from entering into the interior of the carriage from the through hole.

Furthermore, an outer surface of the board body is provided with a top recess and a side recess respectively corresponding to an upper edge and side edges of the rain cover. The top recess is in communication with the side recess. Transverse sliding chutes, inside the board body, at both ends of the top recess are internally provided with locking assemblies. The locking assembly includes latches with toggle blocks and reset springs. The latches are slidably placed inside the transverse sliding chutes at both ends of the top recess through the reset springs. Both ends of the upper edge of the board body are provided with locking jacks corresponding to inserting ends of the latches. The inserting ends are able to be inserted into the locking jacks through free elongation of the reset springs.

Through the adoption of the above-mentioned technical scheme, a mounting structure for the rain cover is provided. The mounting structure is simple in operation, and also can effectively guide rainwater, so that rainwater can be effectively avoided from entering into the interior of the carriage from the ventilation opening.

Furthermore, multiply clamping slots for clamping various function devices are formed in the board body below the rain cover.

Through the adoption of the above-mentioned technical scheme, a plurality of clamping slots for clamping various function devices are formed in the board body below the rain cover, so that the function extension abundancy of the extension board is further improved.

The present disclosure has the following main beneficial effects.

Firstly, according to the function extension board, the rain cover is detachably mounted on the board body on an outer side of the ventilation opening, so that the storage and transportation convenience of the function extension board can be effectively improved.

Secondly, according to the function extension board, the through holes allowing conducting wires to pass through are formed in the board body within the rain cover, so that rainwater can be prevented from entering into the interior of the carriage from the through holes to a certain extent.

Thirdly, according to the function extension board, a rubber plugging piece with an integrally tapered shape and a C-shaped section is provided. During use, the conducting wire is laterally assembled into the taper sleeve, and then the taper sleeve is inserted into the through hole to fixedly seal the conducting wire. The rubber plugging piece has the effects of simple operation and good fixation and sealing effects.

Fourthly, according to the function extension board, the elastic steel plate is arranged inside the taper sleeve. The elastic steel plate has good transverse deformability and also has good axial support force, so that radial sealing and axial insertion can be ensured effectively.

Fifthly, according to the function extension board, the sealing lips are arranged inside rubber taper sleeve, and the sealing lips can ensure normal mounting of the conducting wires and also can be mutually embedded into each other to seal the through holes when conducting wires are not mounted.

### BRIEF DESCRIPTION OF THE DRAWINGS

To describe the technical solutions in the embodiments of the present disclosure more clearly, the following briefly describes the accompanying drawings required for describing the embodiments. Apparently, the accompanying drawings in the following descriptions show merely some embodiments of the present disclosure, and a person of ordinary skill in the art may derive other drawings from these attached figures without creative efforts.

FIG. 1 is a structural schematic diagram of a function extension board, viewed in the outer side, of the present disclosure.

FIG. 2 is a structural schematic diagram of the function extension board, viewed in the rear side, of the present disclosure.

FIG. 3 is a top view, corresponding to FIG. 1, of the function extension board of the present disclosure.

FIG. 4 is a perspective view of the function extension board of the present disclosure.

FIG. 5 is an enlarged view of section A in FIG. 1.

FIG. 6 is an enlarged view of section B in FIG. 1.

FIG. 7 is a sectional schematic diagram of FIG. 1 taken along line D-D.

FIG. 8 is a sectional schematic diagram of FIG. 1 taken along line D-D showing a sectioned taper sleeve.

FIG. 9 is an enlarged view of section C in FIG. 8.

FIG. 10 is a structural schematic diagram of an automobile door frame assembled with the function extension board of the present disclosure.

Reference Numerals: 1 board body; 11 board convex edge; 12 board groove; 13 ventilation opening; 14 through hole; 15 top recess; 16 side recess; 17 transverse sliding chute; 2 fly net; 3 rain cover; 41 latch; 42 reset spring; 43 inserting end; 44 toggle block; 45 cover plate; 51 taper sleeve; 511 C-shaped elastic steel plate; 512 rubber layer; 513 sealing lip; 52 flexible connecting member; 6 conducting wire; 7 automobile door and window frame; 8 automobile window lifting glass; and 9 automobile door.

### DETAILED DESCRIPTION OF THE EMBODIMENTS

In combination with the specific embodiments of the present disclosure, the technical scheme in the present disclosure is described clearly and completely. Apparently, the embodiments in the following description are merely a part rather than all of the embodiments of the present disclosure. Based on the embodiments of the present disclosure, all other embodiments obtained by those skilled in the art without creative effect fall in the scope of the present disclosure.

### Embodiment I

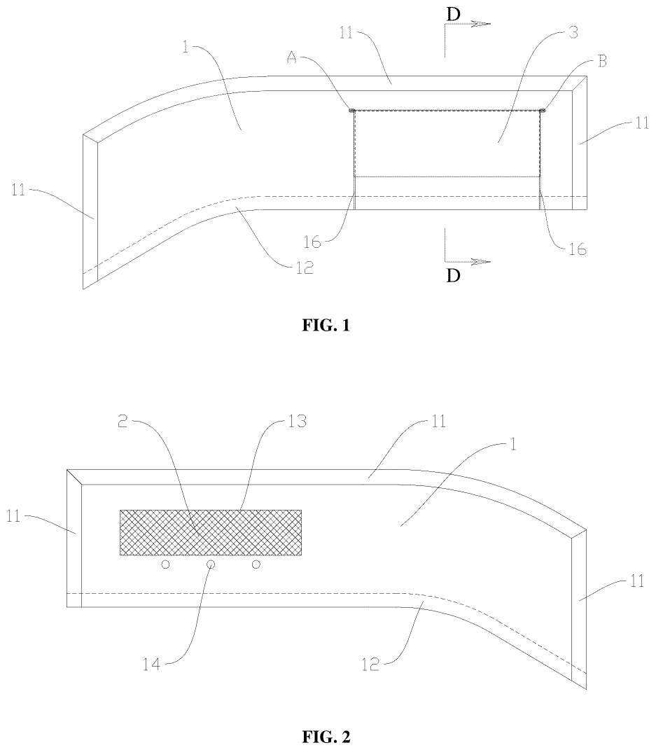

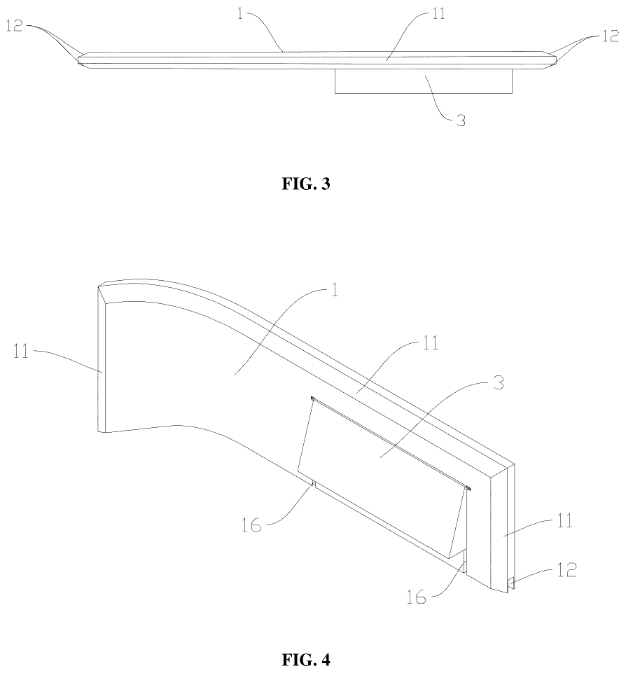

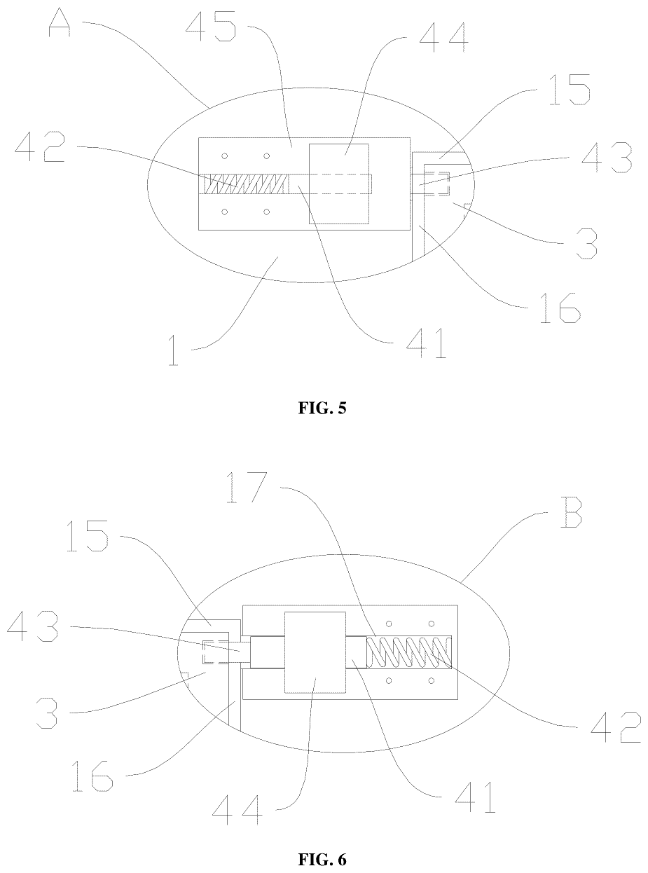

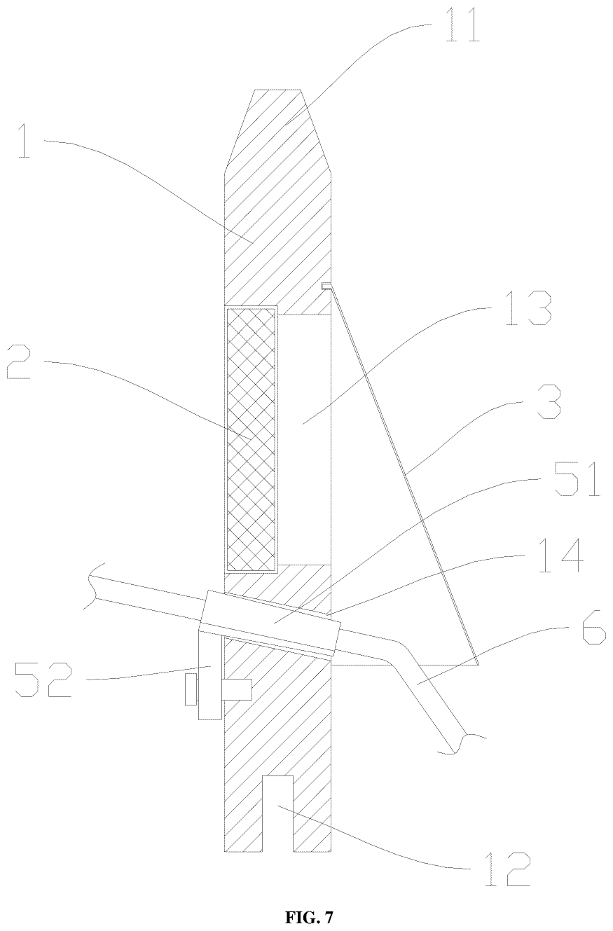

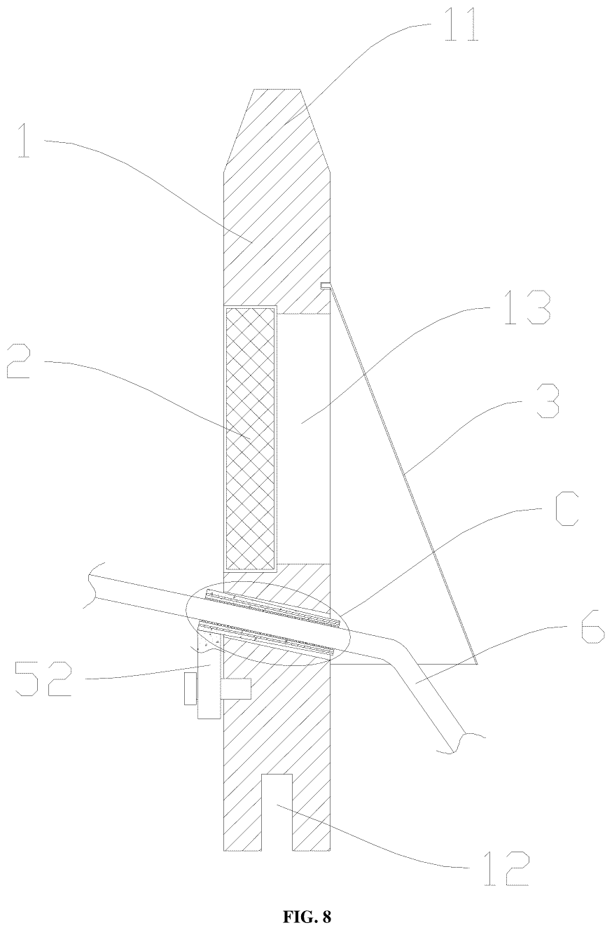

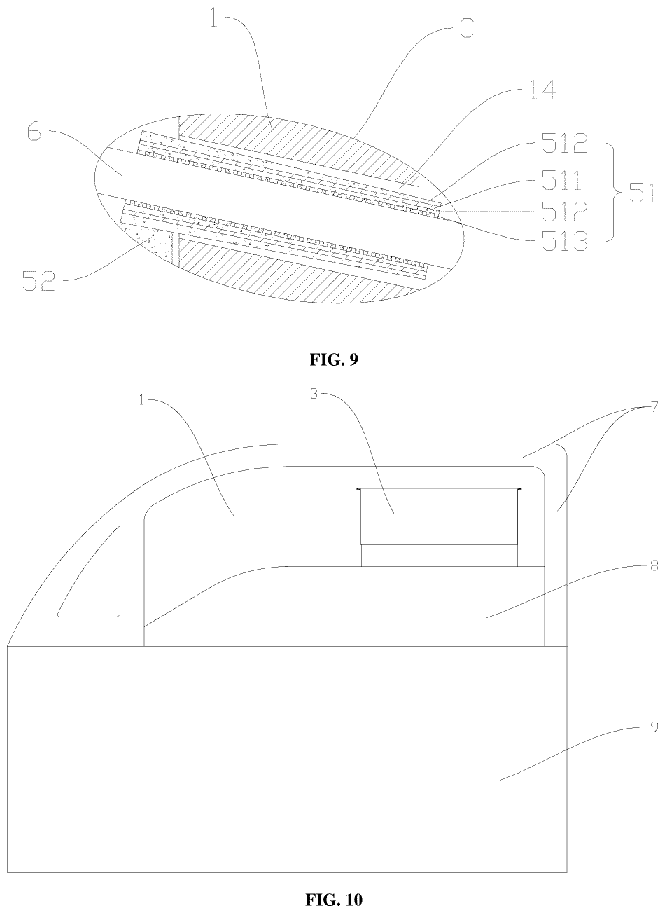

As shown in FIG. 1 to FIG. 10, a function extension board for automobile doors and windows includes a board body 1. An upper edge and side edges of the board body 1 are provided with board convex edges 11 corresponding to grooves of an automobile door and window frame 7 and an automobile door frame. A lower edge of the board body 1 is provided with a board groove 12 corresponding to an upper edge of an automobile window lifting glass 8. A ventilation opening 13 is formed in the board body 1. A fly net 2 is detachably placed on the ventilation opening 13. The board body 1 on an outer side the ventilation opening 13 is detachably provided with a rain cover 3.

An outer surface of the board body 1 is provided with a top recess 15 corresponding to an upper edge of the rain cover 3 and side recesses 16 corresponding to side edges of the rain cover 3. The top recess 15 is in communication with the side recesses 16. Transverse sliding chutes, inside the board body 1, at both ends of the top recess 15 are internally provided with locking assemblies. The locking assembly includes a latch 41 with a toggle block 44 and a reset spring 42. The latches 41 are slidably placed inside the transverse sliding chutes 17 at both ends of the top recess 15 through the reset springs 42. Both ends of the upper edge of the board body 1 are provided with locking jacks corresponding to inserting ends 43 of the latches 41. The inserting ends 43 can be inserted into the locking jacks through free elongation of the reset springs 42.

Through holes 14 allowing conducting wires to pass through are formed in the board body 1 around the ventilation opening 13 within the rain cover 3, and the through hole 14 is an oblique through hole obliquing downwards from inside to outside. The through holes 14 are provided with rubber plugging pieces, the rubber plugging piece includes a taper sleeve 51 with a side opening, and the section of the taper sleeve 51 is C-shaped. The taper sleeve 51 includes a C-shaped elastic steel plate 511 and a rubber layer 512 on the outer surface of the C-shaped elastic steel plate 511. A plurality of sealing lips 513 are placed on a part, on the inner sides of two support plates of the C-shaped elastic steel plate 51, of the rubber layers 512 in a staggered manner. A bigger end of the taper sleeve 51 is provided with a flexible connecting member 52, and the taper sleeve 51 is placed on an inner surface of the board body 1 through the flexible connecting member 52.

A plurality of clamping slots for clamping various function devices are formed in the board body 1 below the lower side of the rain cover 3.

The operation principle of the function extension board for automobile doors and windows is as follows.

During the mounting of the function extension board, the automobile window lifting glass 8 is moved downwards, the extension board is obliquely embedded and placed in the automobile door and window frame 7, and the upper edge and the side edges of the board body 1 are embedded into the grooves of the automobile door and window frame 7. And then, the automobile window lifting glass 8 is moved upwards, so that the upper edge of the automobile window lifting glass 8 is embedded into the board groove 12 in the lower edge of the function extension board. Thus, the mounting of the function extension board on the automobile door and window is realized.

The toggle blocks 44 are toggled outwards transversely, so that the inserting ends 43 of the latches 41 are moved out from the locking jacks in the top of the board body 1, and then the rain cover 3 is detached. The mounting of the rain cover 3 can be realized by reversing above operation. When the rain cover 3 is mounted on the board body 1, the upper edge and the side edges of the rain cover 3 are respectively embedded into the top recess 15 and the side recesses 16 outside the board body 1. The top recess 15 is in communication with the side recesses 16 to form a drainage slot so as to drain accumulated water at the joint of the rain cover 3 and the board body 1.

In a case that the conducting wire 6 needs to be connected to the outside of an automobile from the inside of a carriage, the taper sleeve 51 is removed from the through hole 14, and the conducting wire 6 passes through the through hole 14. And then, the conducting wire 6 is laterally placed into the taper sleeve 51, and then the taper sleeve 51 is inserted into the through hole 14 to realize fixation and sealing of the conducting wire 6. In a case that the taper sleeve 51 is not inserted with the conducting wire 6, a passage inside the taper sleeve 51 is sealed by the sealing lips 513, embedded with each other, on the inner side of the taper sleeve 51.

1. A function extension board for automobile doors and windows, comprising:
a board body, having an upper edge, a lower edge and side edges, the upper edge and side edges being provided with board convex edges corresponding to grooves of an automobile door and window frame, and an automobile door frame, and the lower edge of the board body being provided with a board groove corresponding to an upper edge of an automobile window lifting glass; and
a ventilation opening formed in the board body wherein the board body on an outer side of the ventilation opening is detachably provided with a rain cover.

2. The function extension board for automobile doors and windows according to claim 1, further comprising a fly net detachably placed on the ventilation opening.

3. The function extension board for automobile doors and windows according to claim 2, wherein the board body further comprises through holes allowing conducting wires to pass through the board body around the ventilation opening within the rain cover.

4. The function extension board for automobile doors and windows according to claim 3, wherein the through holes are provided with rubber plugging pieces, each of the rubber plugging pieces comprises a taper sleeve with a side opening, and a section of the taper sleeve is C-shaped.

5. The function extension board for automobile doors and windows according to claim 4, wherein the taper sleeve comprises a C-shaped elastic steel plate and a rubber layer on an outer surface of the C-shaped elastic steel plate.

6. The function extension board for automobile doors and windows according to claim 5, further comprising a plurality of sealing lips placed on a part, on inner sides of two support plates of the C-shaped elastic steel plate, of the rubber layers in a staggered manner.

7. The function extension board for automobile doors and windows according to claim 4, wherein a bigger end of the taper sleeve is provided with a flexible connecting member, and the taper sleeve is placed on an inner surface of the board body through the flexible connecting member.

8. The function extension board for automobile doors and windows according to claim 3, wherein each of the through holes is an oblique through hole obliquing downwards from inside to outside.

9. The function extension board for automobile doors and windows according to claim 1, wherein an outer surface of the board body is provided with a top recess and side recesses respectively corresponding to an upper edge and side edges of the rain cover, the top recess are in communication with the side recess;
transverse sliding chutes, inside the board body, at both ends of the top recess are internally provided with locking assemblies, the locking assemblies comprise latches with toggle blocks and reset springs, the latches are slidably placed inside the transverse sliding chutes at both ends of the top recess through the reset springs, both ends of the upper edge of the board body are provided with locking jacks corresponding to inserting ends of the latches, and the inserting ends are able to be inserted into the locking jacks through free elongation of the reset springs.

10. The function extension board for automobile doors and windows according to claim 1, further comprising a plurality of clamping slots for clamping various function devices formed in the board body below the rain cover.
